(19) United States
(12) Patent Application Publication
(10) Pub. No.: US 2020/0132132 A1
(43) Pub. Date: Apr. 30, 2020

(54) ELECTRIC VEHICLE TRANSMISSION APPARATUS AND METHOD FOR MAKING THE SAME

(71) Applicant: INDUSTRIAL TECHNOLOGY RESEARCH INSTITUTE, HSIN-CHU (TW)

(72) Inventors: MENG-RU WU, TAIPEI (TW); CHIA TSAO, NEW TAIPEI (TW); PO-WEN CHEN, TAINAN (TW); LI-TE HUANG, YILAN CITY (TW); JUI-TANG TSENG, HSINCHU (TW)

(21) Appl. No.: 16/282,632

(22) Filed: Feb. 22, 2019

(30) Foreign Application Priority Data
Oct. 29, 2018 (TW) 107138148

(51) Int. Cl. F16D 23/04; F16H 61/18; F16H 63/30; F16D 11/14

(52) U.S. Cl. CPC F16D 23/04; F16H 61/18; F16H 63/304; F16D 2023/141; F16H 2063/3063; F16H 2063/3093; F16D 11/14

(57) ABSTRACT

An electric vehicle transmission method includes the steps of: detecting a gear-shift command; judging if the gear-shift command is in conflict, if it is in conflict, then it returns back to the step of detecting the gear-shift command while if it is not in conflict, then proceeds to the next step; proceeding to a synchronized position, a dispelling fork drives a synchronizer to make the synchronizer move from the original gear position to a synchronized position, and the dispelling fork does not move within a synchronized time; and proceeding to a target position, the dispelling fork drives the synchronizer again to make the synchronizer move to the target gear position.

### CROSS REFERENCE TO RELATED APPLICATION

This application also claims priority to Taiwan Patent Application No. 107138148 filed in the Taiwan Patent Office on Oct. 29, 2018, the entire content of which is incorporated herein by reference.

### BACKGROUND OF THE DISCLOSURE

### 1. Field of the Disclosure

An electric vehicle transmission apparatus and method for making the same, and more particularly to an apparatus and method capable of stably perform gear shifting and capable of eliminating or reducing vibration generated during the gear shifting process.

### 2. Description of the Prior Art

The existing electric vehicle or the hybrid electric vehicle has a clutch device, as the vehicle perform gear shifting, the clutch device will disconnects the coupling relationship between the power source and the transmission device. When it comes to engaging the target position gear, the power source and the transmission device will be coupled with each other again, the driver will smoothly perform gear shifting.

However, most of the existing electric vehicles do not have a multi-speed transmission system or a clutch device, so the driver will feel the vibration and noise caused by the non-synchronized action between the gears during the gear shifting process. In addition, this non-synchronized action often cause damage to the engaged position gears.

### SUMMARY OF THE DISCLOSURE

The disclosure of an electric vehicle transmission device includes:

a transmission source;
a transmission shaft coupled with the transmission source;
a first-position gear furnished at the transmission shaft;
a second-position gear furnished at the transmission shaft;
a synchronizer being furnished at the transmission shaft is positioned between the first-position gear and the second-position gear;
a dispelling fork coupled with the synchronizer;
a dispelling fork power source coupled with the dispelling fork; and
a controlling unit electrically connected to the transmission source and the dispelling fork power source;
wherein, the dispelling fork drives the synchronizer to make the synchronizer move from an original gear position to a synchronized position, afterward, the dispelling fork dose not move at a synchronized time; the dispelling fork drives the synchronizer again to make the synchronizer move to the target gear position where the original gear position is a first-position gear or a second-position gear and the target gear position is the second-position gear or the first-position gear.

The disclosure of an electric vehicle transmission method includes the following steps:

detecting a gear-shift command;
judging if the gear-shift command is in conflict, if it is in conflict, then it returns back to the step of detecting the gear-shift command while if it is not in conflict, then proceeds to the next step;
proceeding to a synchronized position, a dispelling fork drives the synchronizer to make the synchronizer move from the original gear position to a synchronized position and do not move at a synchronized time;
proceeding to a target position, the dispelling fork drives the synchronizer again to make the synchronizer move to a target gear position.

### BRIEF DESCRIPTION OF THE DRAWINGS

The accomplishment of this and other objects of the disclosure will become apparent from the following description and its accompanying drawings of which:

FIG. 1 is a block diagram of an electric vehicle transmission apparatus of the disclosure;

FIG. 2 is a schematic drawing of an electric vehicle transmission apparatus of the disclosure;

FIG. 3 is a flow chart of an electric vehicle transmission apparatus of the disclosure;

FIG. 4 is a schematic time chart showing an electric vehicle transmission method of the disclosure;

FIG. 5 is a schematic diagram of a synchronizer in neutral position;

FIG. 6 is a schematic diagram of an engaging sleeve positioned in a synchronized position;

FIG. 7 is a schematic diagram of an engaging sleeve engaging a gland (the second gland).

### DETAILED DESCRIPTION OF THE PREFERRED EMBODIMENT

The following descriptions are embodiments of the disclosure employing some particular concrete examples. Those people skilled in the art are capable of easily realizing the advantages and efficacies of the disclosure through the content disclosed by the patent specification of the disclosure.

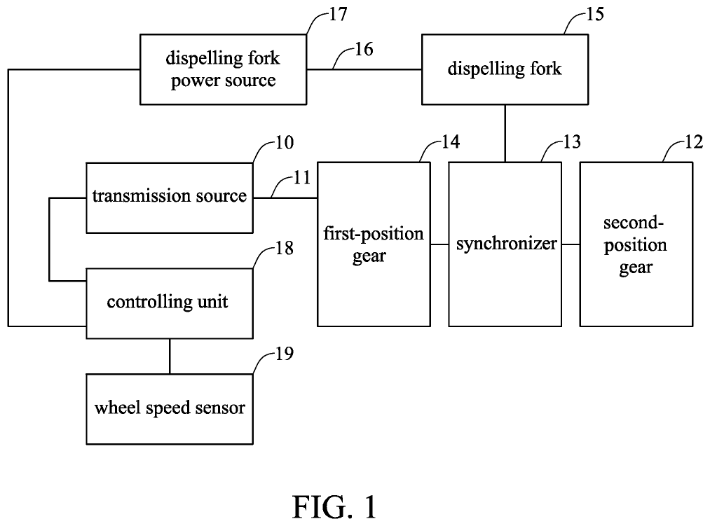

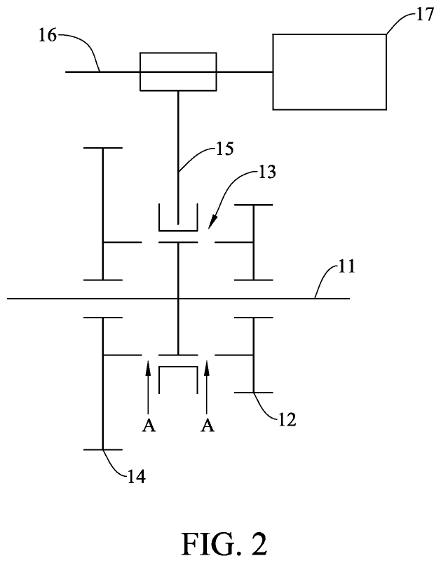

FIG. 1 is a block diagram of an electric vehicle transmission apparatus of the disclosure and FIG. 2 is a schematic drawing of an electric vehicle transmission apparatus of the disclosure. As shown in FIG. 1 and FIG. 2, the electric vehicle transmission apparatus of the disclosure include a transmission source (10), a transmission shaft (11), a first-position gear (14), a synchronizer (13), a second-position gear (12), a dispelling fork (15), a screw (16), a dispelling fork power source (17) and a control unit (18).

The transmission source (10) being a motor is coupled with the transmission shaft (11) which is further coupled with the first-position gear (14), the synchronizer (13) and the second-position gear (12).

In order to dispel the synchronizer (13), the dispelling fork (15) is coupled with the synchronizer (13). The dispelling fork (15) is also coupled with the screw (16) which is sequentially coupled with the dispelling fork power source (17) which is a motor.

The synchronizer (13) is a device that is capable of achieving synchronizing effect when the gears are mutually engaged with each other during the transmission ing process. In the transmission ing process, the circumferential speeds of the pair of gears ready to be engaged each other should be approached to be equal in order to smoothly catch each other. Otherwise, the gears' life wile be affected since impact and noise will be generated between the teeth of the pair of gears. The basic principle of the synchronizer is to perform friction between the two gears by the tapered surface of the synchronizing ring making the speed of the faster one slowed down and the speed of the slower one speed up. The gears can only be engaged each other after the synchronization is achieved.

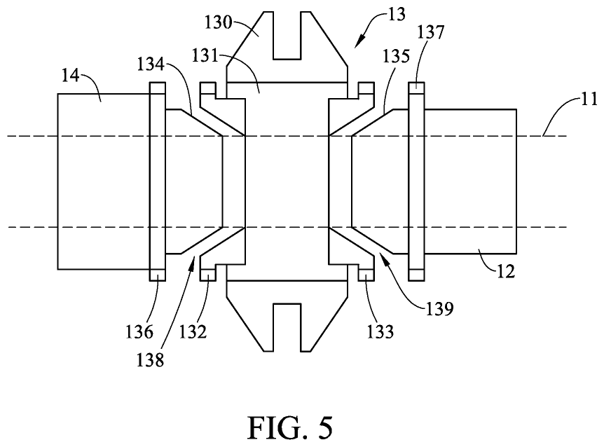

FIG. 5 is a schematic diagram of a synchronizer in neutral position. As shown in FIG. 5, the synchronizer (13) includes an engaging sleeve (130), a hub (131), a first synchronizing ring (132), a second synchronizing ring (133), a first friction ring set (138), a second friction ring set (139), a first tapered surface (134), a second tapered surface (135), a first gland (136) and a second gland (137).

There is a spline (not shown in the Figure) furnished in the engaging sleeve (130) and there is also a spline (not shown in the Figure) furnished in the hub (131) where the spline in the engaging sleeve (130) is engaged with the spline in the hub (131) in such a way that they are capable of sliding against each other. Moreover, external teeth being furnished in the outer portions of the first synchronizing ring (132), the second synchronizing ring (133), the first gland (136) and the second gland (137) respectively is engaged with the spline of the engaging sleeve (130) and are, in integral manner, combined with the first tapered surface (134) of the first friction ring set (138), the second tapered surface (135) of the second friction ring set (139) to achieve a transmission position.

Both the first friction ring set (138) and the second friction ring set (139) are provided with bushing ring and a friction ring (not shown in the Figure) while the first tapered surface (134) and the second tapered surface (135) are furnished at the outer parts of the bushing ring. Moreover, the friction ring is tightly combined with the transmission shaft (11). What is more, the first gland (136) and the second gland (137) are secured with the first-position gear (14) and second-position gear (12) respectively. As the engaging sleeve (130) engages with the first synchronizing ring (132) and the first gland (136), the first synchronizing ring (132) and the bushing ring together with the friction ring on the first friction ring set (138) can be combined in integral manner, thereby, to have the power output to the first-position gear (14). Similarly, as the engaging sleeve (130) engages with the second synchronizing ring (133) and the second gland (137), the second synchronizing ring (133) and the bushing ring together with the friction ring on the second friction ring set (139) can be combined in integral manner, thereby, to have the power output to the second-position gear (12).

As shown also in FIG. 5, the transmission shaft (11) sequentially passes through the first-position gear (14), the first friction ring set (138), the first synchronizing ring (132), the hub (131), the second synchronizing ring (133), and the second friction ring set (139). Moreover, the second-position gear (12) is secured to the hub (131) through the spline. When the engaging sleeve (130) is not engaged, the transmission shaft (11) is in an idling state and is not performing power output.

The first gland (136) being positioned adjacent to the first-position gear (14) is furnished at the first tapered surface (134) which is coupled with the first-position gear (14).

Both ends of the hub (131) are coupled with the first synchronizing ring (132) and the second synchronizing ring (133) respectively. The engaging sleeve (130) being coupled with the hub (131) through the internal spline in the engaging sleeve (130) and the external spline on the hub (131) is dispelled by the dispelling fork (15) (see FIG. 1) and has its internal spline selectively engage with either the external teeth of the first synchronizing ring (132) or the external teeth of the second synchronizing ring (133).

The second tapered surface 134 is coupled with the second-position gear 12. The second gland 137 is disposed on the second tapered surface 134 and adjacent to the second-position gear 12. The interior of the engaging sleeve 130 can selectively engage the exterior of the second gland (137) or the exterior of the first gland (136).

As shown also in FIG. 1, The control unit (18) being electrically connected to the transmission source (10) and the dispelling fork power source (17) is further electrically connected to a wheel rotating speed sensor (19).

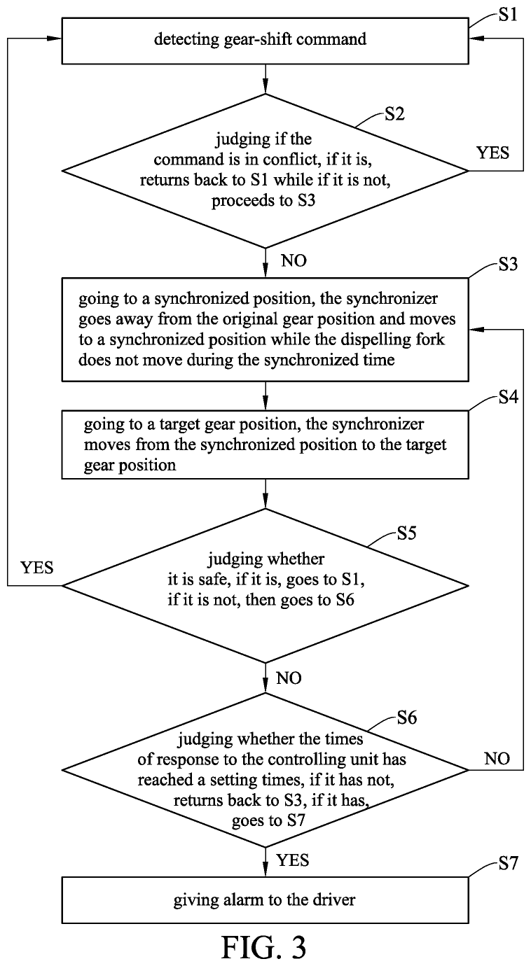

FIG. 3 is a flow chart of the electric vehicle transmission apparatus of the disclosure. As shown in FIG. 3, the electric vehicle transmission method includes the following steps:

Step S1, detecting a gear-shift command. The control unit (18) detects if a gear-shift command is generated. If the control unit (18) detects that a gear-shift command is generated, it proceeds to the next step S2.

Step S2, judging if the target gear position of the gear-shift command is in conflict with the engaged position gear. In accordance with the gear-shift command, the control unit (18) detects if the engaged position gear is in conflict with the target gear position of the gear-shift command. If it is not in conflict, for example, if the gear-shift command is switched to the first-position gear (14), however, at this point, the engaged position gear is not at the first-position gear (14), then, goes to the next step S3. However, if it is in conflict, for example, if the target gear position of the gear-shift command is switched to the first-position gear (14) while the engaged position gear is also in first-position gear (14), then it returns back to previous step S1. The step S1 and the step S2 are foolproof steps.

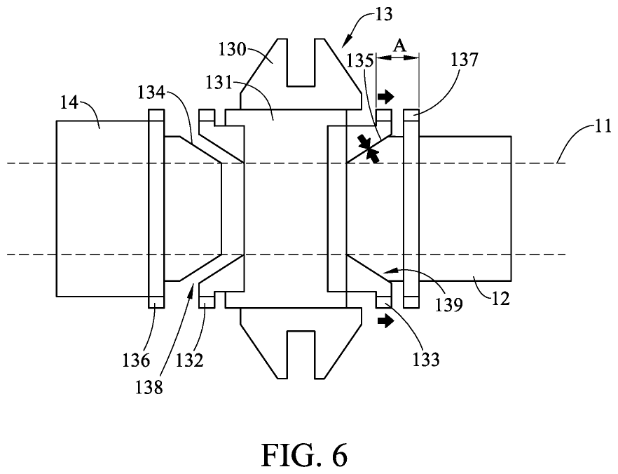

Step S3, goes to a synchronized position. Referring to FIG. 1 and FIG. 6, the control unit (18) instructs the dispelling fork power source (17) to drive the screw (16), and the screw (16) drives the dispelling fork (15) to disengage the synchronizer (13) from the engaged gear position (original gear position), then goes to a synchronized position and do not move within a synchronized time. For example, if the transmission command is changed from the first-position gear (14) to the second-position gear (12), and the screw (16) drives the dispelling fork (15) to make the synchronizer (13) disengage from the engaged first-position gear (14) and goes to a synchronized position.

In short, the synchronizer (13) moves from the original gear position to a synchronized position in accordance with the transmission command. To explain further, the dispelling fork (15) dispels the engaging sleeve (130) so that the engaging sleeve 130 moves away from the first gland (136) and moves to the second gland (137), and the engaging sleeve (130) moves to a synchronized position which is the gap to be engaged where the synchronizing ring (the first synchronizing ring (132) or the second synchronizing ring (133) of the synchronizer (13) contacts the friction ring set (the first friction ring set (138) or the second friction ring set (139)). Moreover, the engaging sleeve (130) is not engaged with the gland (the first gland (136) or the second gland (137)).

Step S4, proceeding to a target gear position. Time after the synchronized position, the screw (16) drives the dispelling fork (15) again to make the synchronizer (13) engage with the position gear (target gear position) assigned by the gear-shift command. For example, if the target gear position is the first-position gear (14). Time after the synchronized position, the screw (16) again drives the dispelling fork (15) to make the synchronizer (13) engage with the first-position gear (14). In short, time after the synchronized position, the synchronizer (13) is moved from the synchronized position A to a target gear position. The synchronized time can be from 50 ms to 500 ms.

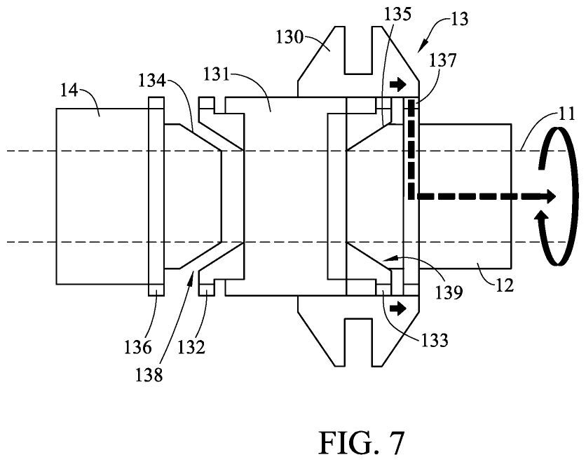

To explain further, after a synchronized time, as shown in FIG. 7, the engaging sleeve (130) moves from the synchronized position to the target gear position to engage with the gland of the target gear position where the target gear position is the second-position gear (12) and the gland is the second gland (137). Therefore, after the synchronized time, the engaging sleeve (130) moves from the synchronized position A to the second-position gear (12) and engages with the second gland (137).

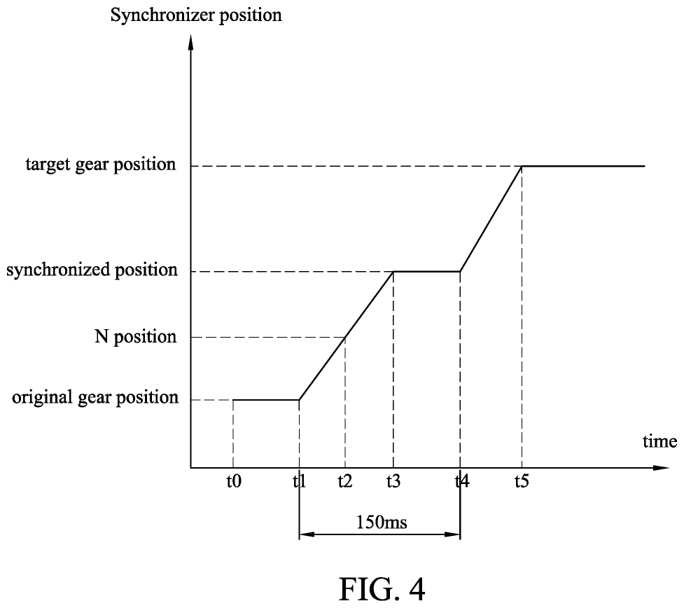

Referring to FIG. 4, to change from the second-position gear (12) to the first-position gear (14). At the time between t0˜t1, a gear-shift command is received by the controlling unit (18). The dispelling fork (15) drives the synchronizer (13) to make it disengage with the second-position gear (12). At this point, the synchronizer (13) moves from the original gear position to a neutral position as shown in FIG. 4, the moving time is t1˜t2. The dispelling fork (15) continues to drive the synchronizer (13) to make it move from the neutral position to the synchronized position at a moving time between t2˜t3.

The synchronizer (13) enters the synchronous position (as indicated in FIG. 4, which is located between the first gear position and the neutral position), and during the time t3˜t4, the synchronizer (13) stops acting, this time period is the above-mentioned synchronized time. The synchronizer (13) moves again from the synchronized position to a engaged gear position, and the moving time of the synchronizer (13) is t4 to t5. After the time t5, the synchronizer (13) engages the first-position gear (14). As shown in FIG. 4, t3˜t4 is the synchronized time period.

Step S5, judging whether it is safe, that is, judging whether it is in correct position determined by the wheel rotating speed. The wheel rotating speed sensor (19) senses the wheel rotating speed and transmits the wheel rotating speed signal to the control unit (18). If it is safe, the wheel rotating speed is the rotational speed generated by the engaged position gear of the corresponding target gear position, then, the control unit (18) does not actuate, and proceeds back to Step S1

If it is unsafe, then, the wheel rotating speed is not the rotating speed generated by the engaged position gear of the corresponding target gear position, thereby, the control unit (18) is making the dispelling fork (15) to drive the synchronizer (13) to disengage it from the engaged position gear of the target gear position, and proceeds to Step S6.

Step S6: judging whether the number of response has reached a setting number of times, that is, judging whether the mechanism is abnormal. If the number of response given to the controlling unit (18) does not achieve a setting number of times, proceeds back to Step S3. However, if the number of response given to the controlling unit (18) achieves a setting number of times, then, proceeds to Step S7.

The response is the case that the wheel rotating speed is not the rotating speed generated by the engaged position gear of the corresponding target gear position, and the synchronizer (13) is disengaged from the message of the engaged position gear of engaged target gear position. The number of setting is at least one or two through twenty times.

Step S7, giving alarm to the driver. The control unit (18) gives an alarm to the driver that the wheel rotating speed is still not the rotational speed generated by the corresponding position gear. The alarm can be sound, light, or wireless message.

In summary, by the use of the synchronizer (13) and the synchronized time, the “electric vehicle transmission apparatus and method for making the same” of the disclosure is capable of attenuate or lower the generated vibration.

In addition, the steps S3˜S4 of the electric vehicle transmission method of the disclosure can be regarded as an open loop, and by the use of the detection of the closed loop in step S5, it can make the disclosure become a gear-shift method of open loop and gear-shift and detecting method of an semi-open loop.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An electric vehicle transmission apparatus, comprising:
a transmission source;
a transmission shaft coupled with the transmission source;
a first-position gear furnished at the transmission shaft;
a second-position gear furnished at the transmission shaft;
a synchronizer being furnished at the transmission shaft is positioned between the first-position gear and the second-position gear;
a dispelling fork coupled with the synchronizer;
a dispelling fork power source coupled with the dispelling fork; and
a controlling unit electrically connected to the transmission source and the dispelling fork power source;
wherein, the dispelling fork drives the synchronizer to make the synchronizer move from an original gear position to a synchronized position, afterward, the dispelling fork dose not move at a synchronized time; the dispelling fork drives the synchronizer again to make the synchronizer move to the target gear position where the original gear position is a first-position gear or a second-position gear and the target gear position is the second-position gear or the first-position gear.

2. The electric vehicle transmission apparatus as claimed in claim 1, wherein the dispelling fork power source is coupled with a screw and the screw is coupled with the dispelling fork.

3. The electric vehicle transmission apparatus as claimed in claim 1, wherein both the dispelling fork power source and the transmission source are motors.

4. The electric vehicle transmission apparatus as claimed in claim 1, wherein the synchronizer further comprising an engaging sleeve, a hub, a first synchronizing ring, a second synchronizing ring, a first tapered surface, a second tapered surface, a first gland and a second gland, the transmission shaft penetrates sequentially through first-position gear, the first tapered surface, the first synchronizing ring, the hub, the second synchronizing ring and the second tapered surface, where the first gland is furnished on the first tapered surface, the second gland is furnished on the second tapered surface, and the engaging sleeve is furnished at the hub.

5. The electric vehicle transmission apparatus as claimed in claim 4, wherein the internal part of the engaging sleeve is engaged with the external parts of both the first synchronizing ring and the second synchronizing ring while the internal part of the engaging sleeve is also engaged with both the external parts of the second gland and the first gland.

6. The electric vehicle transmission apparatus as claimed in claim 5, wherein the synchronizer further comprising a first friction ring set and a second friction ring set; both the first friction ring set and the second friction ring set have a bushing ring and a friction ring respectively; both the first tapered surface and the second tapered surface are furnished at the external part of the bushing rings respectively; the friction rings are tightly combined with the transmission shaft.

7. The electric vehicle transmission apparatus as claimed in claim 5, wherein the synchronized position is the gap to be engaged where the synchronizing ring contacts the friction ring set, and the engaging sleeve is not engaged with the gland, and where the synchronized ring is a first synchronizing ring or the second synchronizing ring and the friction ring set is a first friction ring set or the second friction ring set, and the gland is a first gland or the second gland.

8. The electric vehicle transmission apparatus as claimed in claim 5, wherein the spline furnished at both the internal part of the engaging sleeve and at the external part of the hub can be slid along each other.

9. The electric vehicle transmission apparatus as claimed in claim 5, wherein the external teeth furnished at the external parts of the first synchronizing ring, the second synchronizing ring, the first gland and the second gland can be engaged with the spline of the engaging sleeve respectively.

10. The electric vehicle transmission apparatus as claimed in claim 1, wherein the synchronized time is 50 ms˜500 ms.

11. An electric vehicle transmission method, comprising the following steps:
detecting a gear-shift command;
judging if the gear-shift command is in conflict, if it is in conflict, then it returns back to the step of detecting the gear-shift command while if it is not in conflict, then proceeds to the next step;
proceeding to a synchronized position, a dispelling fork drives the synchronizer to make the synchronizer move from the original gear position to a synchronized position and do not move at a synchronized time;
proceeding to a target position, the dispelling fork drives the synchronizer again to make the synchronizer move to a target gear position.

12. The electric vehicle transmission method as claimed in claim 11, further comprising of judging whether it is safe, if it is safe, the wheel rotating speed is the rotational speed generated by the engaged position gear of the corresponding target gear position, then proceeds back to the step of detecting the gear-shift command.

13. The electric vehicle transmission method as claimed in claim 12, further comprising of judging whether it is safe, if it is not safe, the dispelling fork drives the synchronizer to make it move away from the target gear position and proceeds to the step of judging whether the response has reached a setting number of times.

14. The electric vehicle transmission method as claimed in claim 13, further comprising of judging whether the number of response has reached a setting number of times, if the number of response given to the controlling unit does not achieve a setting number of times, then, proceeds back to step of going to a synchronized position.

15. The electric vehicle transmission method as claimed in claim 14, further comprising of judging whether the number of response has reached a setting number of times, if the number of response given to the controlling unit has achieved a setting number of times, then, proceeds to the step of giving an alarm to the driver.

16. The electric vehicle transmission method as claimed in claim 15, wherein the number of setting is at least one or two through twenty times.

17. The electric vehicle transmission method as claimed in claim 15, wherein the judged response is that the wheel rotating speed is not the rotating speed generated by the engaged position gear of the corresponding target gear position.

18. The electric vehicle transmission method as claimed in claim 15, wherein the control unit gives an alarm to the driver that the wheel rotating speed is not the rotational speed generated by the corresponding engaged position gear, and the alarm can be sound, light, or wireless message.

19. The electric vehicle transmission method as claimed in claim 11, wherein the synchronized time is 50 ms˜500 ms.

20. The electric vehicle transmission method as claimed in claim 11, wherein the synchronized position is the gap to be engaged where a synchronizing ring contacts a friction ring set, and an engaging sleeve is not engaged with a gland, and where the synchronized ring is a first synchronizing ring or a second synchronizing ring while the friction ring set is a first friction ring set or the second friction ring set, and the gland is a first gland or a second gland.
